(19) United States
(12) Patent Application Publication
(10) Pub. No.: US 2014/0365989 A1
(43) Pub. Date: Dec. 11, 2014

(54) INFORMATION PRODUCT BUILDER, PRODUCTION AND DELIVERY SYSTEM

(71) Applicant: Innodata India Pvt. Ltd, New Delhi (IN)

(72) Inventors: Deepak AGRAWAL, Noida (IN); Arun Kumar AGRAWAL, Noida (IN)

(73) Assignee: Innodata India Pvt. Ltd, New Delhi (IN)

(21) Appl. No.: 14/291,772

(22) Filed: May 30, 2014

(30) Foreign Application Priority Data
May 30, 2013 (IN) 1636/DEL/2013

(51) Int. Cl. G06F 9/44; H04L 29/08

(52) U.S. Cl. CPC G06F 8/20; H04L 67/10
USPC 717/100

(57) ABSTRACT

Methods and Systems to provide a production and delivery system, which acts as complete solution package, having in-built dynamic process flow designing, routing-rules, specification or data modeling capability, in-built specialized process libraries for the rapid building of execution platform and product libraries for supporting rapid processing and transformation of information products, providing a mechanism for rapid process flow designing, integrated management of information products processing and data transformation with accuracy.

### CROSS-REFERENCE TO RELATED APPLICATIONS

This application claims priority to Indian Application No. 1636/DEL/2013, filed May 30, 2013, which is hereby incorporated by reference in its entirety.

### TECHNICAL FIELD

The present invention generally relates to data processing, more particularly to workflow system technologies and mechanism.

### BACKGROUND

Rapid changes in digital content technology have created the need to improve technology platforms to meet the changing data processing requirements. For example, patent application US20120227044A1 mentions a web-based technology platform, which allows creation of work steps, tasks, role assignments, and/or routings. The said application talks of the creation of dashboards, automatic notification by alerts, parallel, loop-backs, sequential, multi-choice, conditional forward or conditional processes, etc. Some of the conventional systems including this system mention that there is zero coding or programming effort required for designing and re-designing activity when there are one or more changes in the data processing requirements. There is also no requirement for redeploying application in such a scenario due to on the fly configuration of workflow. In some cases, storing workflow directly in a relational database was introduced to avoid redeployment activities, whenever there is a change in workflow. Storing of fields/rules in rows, which have a greater likelihood of frequent changes, in the form of Key-value pairs was introduced unlike columnar format in the RDBMS to achieve flexibility and to avoid redesigning of tables of RDBMS.

These already existing solutions and technology platforms cater the workflow and process modeling needs only in a generic manner, without solving the needs of providing or designing rapid process solutions, building real-time, cost-effective processing platforms, or providing solution for real-time cross-talking or handshakes among multiple external applications. In a real scenario, where a plurality of applications are required to carry out the myriad of information product processing and data transformation functions, it becomes very complex to achieve cross-talking among these applications in an automated manner to achieve higher data processing efficiency employing minimum effort. The above mentioned scenario further gets complicated where there is a very high requirement of accuracy in processed data coupled with each step of workflow. The very high requirement of accuracy here means accuracy ranging from 99-100%, preferably 99.995%, which means that only 1 character error allowed in every 20,000 thousand characters of data processed, generally seen in digital publishing processes. With conventional systems, communicating with external applications/tools, in such a manner that a specific application is run at the right time, at the right step, by the right user automatically, with the right job priority settings, where the application can open up assigned files as per a user-specific role and user-specific task/s simultaneously, while capturing, updating and scheduling in each transaction for each work unit without any chance of error and additional effort, still remains a problem. Further, capability to listen to messages passed by the external application such that the messages can be utilized for linking with routing-rules in a dynamic way, providing flexibility to carrying out specific tasks in a process in an automated manner or with minimum human intervention as necessary, while accommodating frequent changes in the end-to-end process in real-time without coding/rewriting codes is another problem to be solved. Conventional systems may use a script handler for routing objects by a rule engine, where the script handler is related to external application processes. These conventional systems may mention overcoming the need of custom programming to coordinate the desired operation of the workflow designing with the other applications where interaction in the workflow is desired. However, the conventional systems do not allow usable and effective cross-talking among external applications in an automated manner such that role based, and priority based auto job openings by the external application, with real-time capturing of user performance metrics and metadata for per work-unit or information product, even if external application is used, is possible without introducing of additional step for such metrics capturing activity. Further, existing systems lack one or more of the following:

a) Existing systems don't have or use process solutions like process libraries for rapid workflow designing and/or building of execution platforms, and product libraries for supporting rapid information product processing and managing data transformation; b) Decision making for the selection of an application, role based auto job browsing, and choice of process or product library is not automated for mass scale homogenous processing as human tends to make errors, particularly when large participants are involved working in one or more locations simultaneously. The likelihood of introducing defects and/or heterogeneity during processing increases in such scenarios as well as in scenarios where there is simultaneous handling of a variety of data processing requirements, in one or more locations during parallel and/or conditional processing; and c) achieve and consistently maintain the high accuracy requirements in digital publishing workflow processes.

There is a need for a complete solution package, that not only has an in-built workflow designing, configuration, routing-rules, specification or data modeling capability but also has in-built specialized process and product libraries for rapid building of efficient and cost-effective processing platforms. There is a need for a workflow system having capability to allow cross-talk among external applications, jobs, users, tasks, stages, and automated information flow, and data and ever changing rules management to attain higher flexibility, achieve efficiency, and scalability in a simplified and user-friendly manner, all with high accuracy.

Further, in conventional systems, with respect to usability, virtual simulation to test data processing or publishing processes and process design is not accurate which leads to delays during the execution of processing and often leads to cost increases and frequent re-designing, re-testing and re-implementation in data processing processes, mostly in early stages of the data processing.

### SUMMARY

An object of the invention is to provide a workflow system, which acts as complete solution package, having not only in-built dynamic workflow designing, routing-rules, specification or data modeling capability but also with in-built specialized process libraries for the rapid building of execution platform and product libraries for supporting rapid processing and transformation of information products. The invention offers capability to allow cross-talk among plurality of applications, job, users, tasks, stages, and automated information flow in integrated and automated manner. Further, the workflow system allows work prioritization, and the easy management of frequently and ever-changing rules to manage plurality and variety of data processing processes to attain higher flexibility without the need of re-coding, achieving efficiency, scalability, higher processing capability, and all with very high accuracy. Users can access file servers based on provided role based access rights, which helps boosts security of data, avoids peer interference. The system also provides flexibility to preset end-users in categories such that during the execution of workflow, data can be processed based on the user's-skill and complexity of electronic documents.

Another object of the invention is to provide a mechanism for rapid workflow designing, integrated management of information products processing and data transformation with accuracy, using the workflow system. This mechanism overcomes the above problems of prior art, solves the needs of content and digital publishing workflow processes, and provides process solutions.

The workflow system increases scalability, efficiency and reliability, which enables workflows to scale or run in multiple servers in multiple locations. The said system and its internal modules are not tied to a specific process on a specific machine, and can be load balanced across multiple servers. The system ensures data integrity and reliability. Workflow status data is not lost when server downtime is encountered during operation. It is configured by an administrator as a common platform in design, development, testing and deployment of workflows, where best practice activity libraries can be built complete with rules for managing routing and plurality and variety of data processing processes. These libraries serve as building blocks in the development and configuration of standard solution models for different workflow processes, and additionally make possible offering flexible solutions to users. During the execution of workflows, the same method of invention helps in the review of user and workflow performance, workflow fine-tuning and reconfiguration to achieve optimal performance. The analysis and findings during this phase feeds the activity and workflow design process, enabling continual improvement.

### DESCRIPTION OF THE DRAWINGS

The accompanying drawings, which are incorporated in and constitute a part of this specification, illustrate various embodiments.

FIG. 1 shows a flowchart illustrating a mechanism for rapid workflow designing, and easy, integrated management of information product processing and data transformation with accuracy, according to invention;

FIG. 2 shows a schematic view of the workflow system from a usability perspective; and

FIG. 3 shows an exemplary schematic diagram of a workflow system in multi- location settings according to an embodiment of the present invention.

### DETAILED DESCRIPTION

As required, detailed embodiments are disclosed herein. However, it is to be understood that the disclosed embodiments are merely exemplary and that various and alternative forms may be employed. The figures are not necessarily to scale. Some features may be exaggerated or minimized to show details of particular components. Therefore, specific structural and functional details disclosed herein are not to be interpreted as limiting, but merely as a representative basis for teaching one skilled in the art.

The invention makes possible rapid workflow designing, achieving cross-talking among a plurality of applications in an automated manner to achieve higher data or information products processing efficiency, and managing information products transformation with high accuracy. The invention permits rapid product and workflow setup re-configuration in cost-effective manner while simultaneously accommodating changing information product processing needs. Various aspects of the disclosure are described herein in the context of a system and mechansim for easy management of information products processing and transformation also covering integrated process design and configuration. Those of ordinary skill in the art will realize that the following description is illustrative only and not in any way limiting. Other aspects will readily suggest themselves to such persons having the benefit of this disclosure.

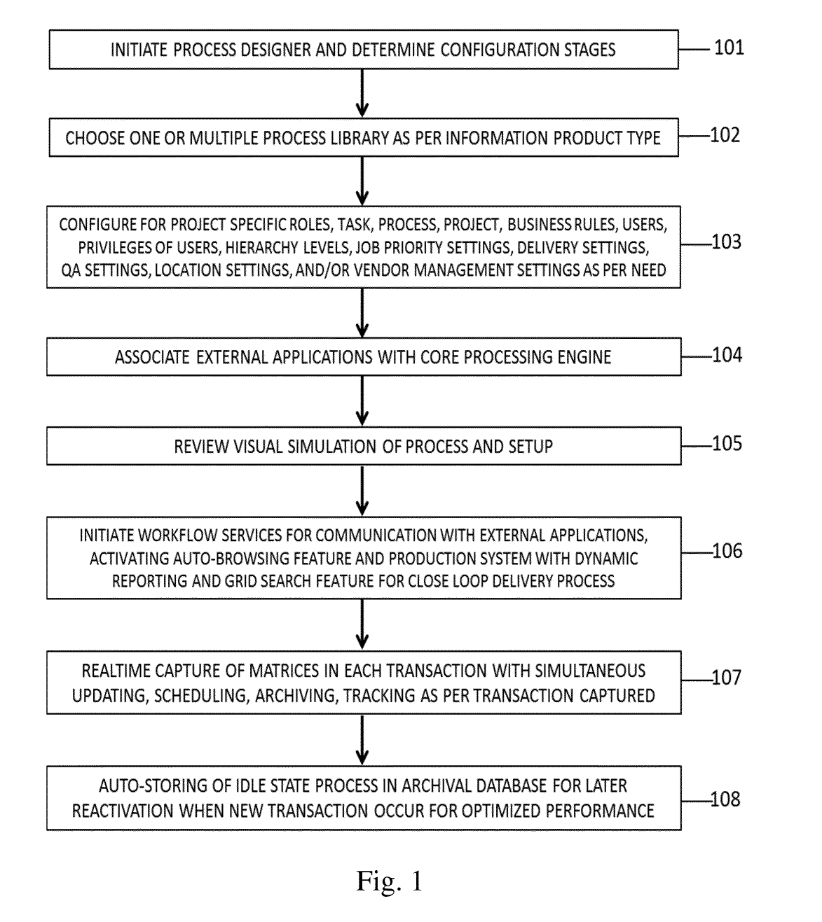

FIG. 1 shows a flowchart of a mechanism for the rapid and easy building of dynamic workflows with high accuracy processing, which involves initiating a process designer and determining configuration stages (101). In step 101, a means for designing process is initiated, and routing-rules relevant information, information product processing process related information, and the same is analysed for determining configurations and process type. In step 102, in accordance with the information product type, one or multiple processes are chosen from a process library, where further information product processing specific configuration or customization to be carried out. In step 103, —configuration is carried out for information product processing—process specific roles, tasks, processes, routing-rules, users, privileges of users, skills, hierarchy levels, job priority settings, automated quality assurance (QA) settings, location settings, as per the analysis carried out in step 101. Here, the configuration is automated, meaning it is carried out by administrator without the need of programming. In this step, a minimum effort is required for carrying out information product processing process specific customization, as matching configuration is also imported with the import of the available process from process library in step 102. Role is two types' workflow role such as operators and non-workflow role such as administrator, supervisor or manager. The workflow roles are part of workflow, where as non-workflow roles are not part of workflow. Multiple roles are created based on analysis of task information, and determined stages. Each role is assigned to a process, provided said role is a part of process, where process privilege is granted to the assigned role. A user-friendly workflow diagram is automatically built in real-time during configuration, which acts as a check for proper configuration. Hierarchy levels for setting number of levels to access a work unit, which can be placed in a folder or a folder within a folder and so on and so forth. For example level 2 is a shipment folder containing a job folder, which in turn contains an actual work unit. Location settings involve one or plurality of geographical location within a country (intra-country) or within different countries (inter-countries) connected by a network. The network can be private network such as LAN, WAN, VPN, Intranet, Internet or cloud. This allows for multi-facility processing. Configuration of information product processing process specific rules is carried out on each stage to make workflow either sequential, parallel or conditional, or a combination thereof. The rules can be created and later modified or deleted using a dynamic rule configuration module. Configuration to make workflow either sequential, parallel or conditional, or a combination thereof is done using a workflow master module and a process master module contained in a means for designing process. This creation, or modification or deletion of users is made possible using a user master module in the means for designing process.

After the above configurations are completed, associations of one or a plurality of external applications or tools with a core processing engine of the workflow system takes place (104). Step 105 involves a review of the visual simulation of the end-to-end process and entire set-up, where stages are shown in tangible graphical representations with associated rules, which can be highlighted for verification, and for ascertaining accuracy in previous steps. This is followed by initiation of workflow services for communication with external application/s, with the automated activation of an auto-browsing feature and execution platform with dynamic reporting and grid search features for real time information flow (106). The activation is done using publishing through Internet Information Services (IIS). As soon as the services are activated, it can be readily used by users, where real-time automated capturing of matrices in each transaction or event takes place while managing transformation of electronic data in each stages of processing, with simultaneous automated updating, scheduling, archiving and tracking as per event captured (107), where scheduling involves creation and scheduling of new workflow instances for execution in runtime memory, archiving involves maintenance of workflow instance state, and tracking logs workflow execution data at the workflow, activity and user level including start and end time-stamps, number of files processed, key performance indicator matrices etc. The automated capturing of real time data related to information product processing is made possible in cost-effective manner using a workflow service module. A workflow service is an ordered set of activities to accomplish a goal such as routing and queuing of transactions, metrics collection etc. In step 108, idle state process is auto-stored in an archival database for later reactivation when new events or transactions occur for optimized performance.

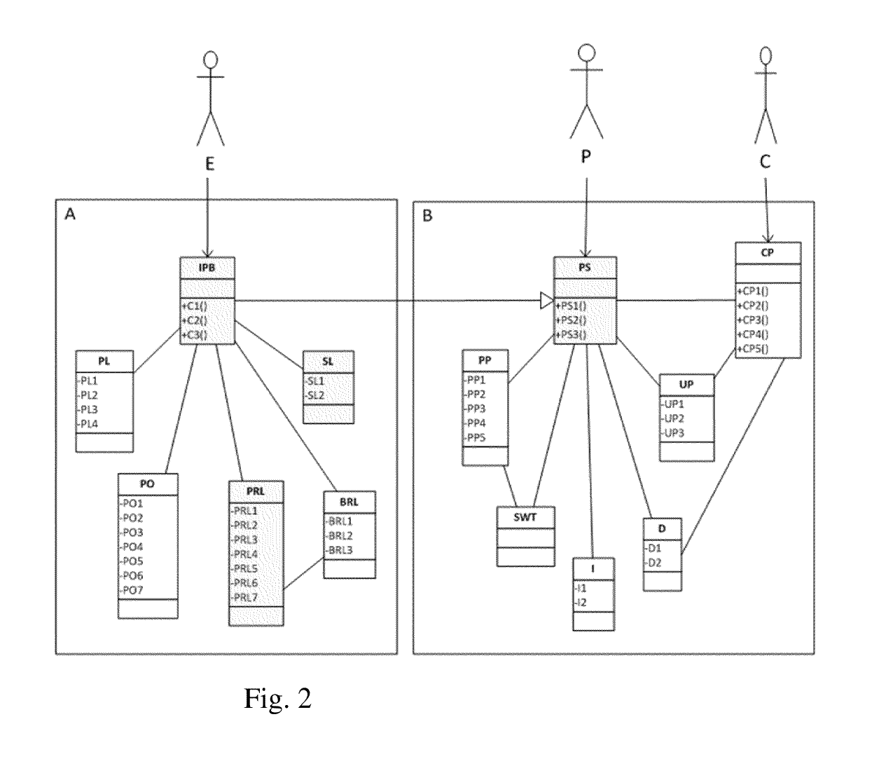

FIG. 2 shows a schematic view of the workflow system from usability perspective, where workflow and information product set-up and configuration (A) and user's execution and usage package (B) is shown in a separate box to understand the usage of components and overall activity of said workflow system by an administrator (E) for rapid and easy build-up without coding for multiple users (P) using the said system at the same time for rapid processing. Information product and workflow builder (IPB) activity is represented by product configurator (c1), process designer (c2) and dynamic rules configurator (c3). The said Information product and workflow builder utilizes product library (PL), software library (SL), process options (PO), process library (PRL) and rules library (BRL) as ready solutions/components for enhancing the speed for carrying out set-up and configuration of workflow and information product (A) to build a dynamic complete solution package for end-users processing functions. The product library provides easy configuration of product type (PL1), feature set/options (PL2) and quality options (PL3). The software library (SL) provides common software applications (SL1), also provides possibility of configuring software-as-a-Service (SL2). The process options (PO) represents single location (PO1), multi-location (PO2) processing capability.

The process library (PRL) enables easy and quick configuration for designing transformation (PRL1), composition (PRL2), authoring (PRL3), XML processing (PRL4) processes, and set-up of role profile (PRL5) and repository (PRL6). The dynamic rules configurator offers easy configuration and set-up of workflow routing which also includes sequential, parallel and conditional process settings (RL1), validation rules (RL2) and criteria (RL3) collectively represented as Rule Library (RL). The rule library is also shown linked to process library (PL) as process library also stores and includes ready-made in-built workflow routing, validation rules and criteria information.

The dynamic complete solution package built for end users execution platform (PS) uses workflow services engine (PS1), rules engine (PS2) and runtime engine (PS3) for realising the Data Processing and transformation Process (PP), providing effective capabilities of ingestion (PP1), inventory management (PP2), mass processing (PP3), quality assurance (PP4) and real-time dashboards (PP5). The processing is supported by software toolset (SWT).

The users execution platform makes use of user profiles (UP) to ensure data security and integrity of information products, with main features of predefined/pre-set access to information product as per role (UP1), access rights (UP2) and user group (UP3) settings. The users execution platform is linked to a data layer (D) needed to store processing information in database/s (D1) and files in file repository (D2). An Infrastructure component (I) is shown linked to end users execution platform, which represents the physical infrastructure used selected from either on-premise data centre/s (I1) and/or private cloud (I2) for data processing and transformation functions.

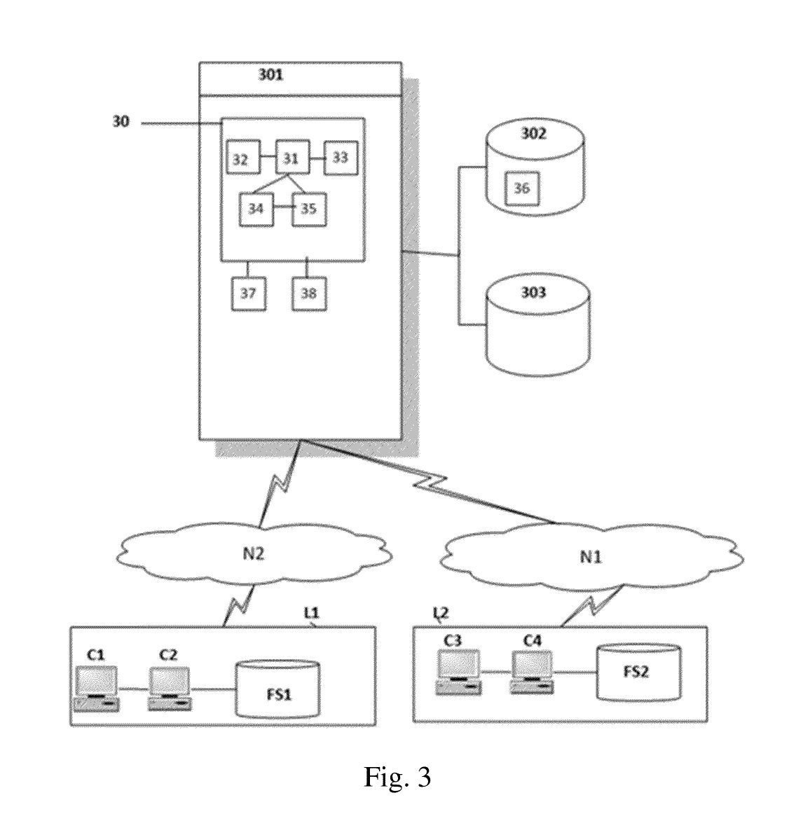

FIG. 3 show an exemplary schematic diagram of a workflow system. The said system includes a server (301), which is accessed by users of client systems (c1,c2,c3,c4), a core processing engine (30), a process library (36) for storing ready-to-use processes, a software library (37) for storing ready-to-use utility software/tools, and one or plurality of file servers (FS1,FS2). A file server is a physical repository of the information products to be processed including interim or intermediary files during processing. A windows archive database (303) and a configuration and metrics database (302) are also provided in the said system, which remain connected to the said server (301).

The core processing engine (30) includes a means designing process (31), a means for configuration of product (32), a routing-rule configurator (33), a module for managing workflow services (34) for capturing of matrices in each transaction, and a workflow runtime module (35) for handling actual execution of the workflow throughout its lifecycle from the creation of workflow instance in runtime memory to the operation and completion of the workflow service. The said means for designing process (31) comprises a Graphical User Interface (GUI) of a role master and role master module for creating, modifying, deleting roles and/or adding role details in said system, a GUI of workflow master and workflow master module for creating workflow, a GUI of a project master module and project master module for creation of desired information product processing process and association of the process with the real-time created workflow or preferably a process selected from a process library (36), a GUI of user master and user master module for creation, or modification or deletion of users, and a GUI of process master and process master module for aiding in configuration to make workflow either sequential or parallel or conditional or their combination together with the routing-rule configurator (33). A GUI of application master and application master module is also provided in means for designing process (31) for easy association of one or plurality of external application with the core processing engine (30) such that cross-talk among applications or tools is made possible among applications, job, users, tasks, stages, and automated information flow for attaining higher flexibility without the need of re-coding, achieving efficiency, scalability, higher processing capability, and more importantly very high accuracy in processed and transformed information product. A GUI of common application and common application module is provided for easy configuration of ready-to-use software utilities/tools such as email utility or zip utility.

The routing-rule configurator (33) comprises a GUI of rule engine configuration module and the rule engine module for creating, modifying or deleting and applying rule in the said system. The rule configurator (33) makes easy configuration of workflow routing, validation rules, and setting of criteria. The rule configurator is designed such that particular information product processing process-specific customization, changes, deployment can be done readily without the requirement of re-designing entire process, coding and re-deployment in real-time in simplified manner by even a person who doesn't have coding skills. The design of rule configurator (33) mainly comprises easy-to-use and easy-to-implement Left Hand Side (LHS) and Right Hand Side (RHS) value configuration for applying conditions based on property of information product for file movement, a means for Rule creation, a means for grouping of rules and a means for application of rules. The said means of designing process (31) together with the rule configurator (33) allows for the creation of defined set of rules such as conditions, criteria, and policies etc. at the workflow activity level and rule sets and policies (rule library) that are independent and accessible to all published workflows. This enables efficient and cost-effective implementation of defined set of rules and policies across the end-users' processing environment. The means for configuration of product (32) works in-sink with the means for designing process (31). The means for configuration of product (32) makes possible easy configuration of transformed product output parameters using measurement unit, item code options of GUI of process master and process master module, and also a GUI of item master. A quality check is required to provide the best possible transforming of information products during critical steps, and check of said transformed product. A group of transformed product (Cluster) is tested for QA. The means for configuration of product (32) also makes Quality Assurance (QA) an automated process and makes possible easy configuration of QA options using GUI of each QA offer, QA assign and rework module, and also easy configuration of product type using file type option of project master module and a GUI of menu master module. The notification process of the QA is also simplified, integrated n the workflow system and automated as the job is approved or rejected. The QA user as per role has the liberty to attach any required document and send a notification to another user as per pre-defined role and permission through the said system, where the QA report generation is also automated.

The core processing engine (30) is used in creating data processing and transformation support workflows, creating activities which are the building blocks of workflows and finally creating defined set of rules which controls the behavior of workflows, where all the creation activities are visual. The means for designing process (31) and the rule configurator (33) allows for the creation of workflow branching, parallel tasks and loopbacks (33) or flow-backs to any point in the workflow. The core processing engine (30) includes functionality for the validation, testing and simulation of workflows which improves the reliability and dependability of workflows when used by end-user during processing/execution. The process library (33) comprises ready-to-pick processes, which are best practices that can be readily used in multiple end-to-end workflow designs and configurations. The process library (33) also stores and includes ready-made in-built workflow routing, validation rules and criteria information. The ready-to-pick process stored in process library generally comprises information product transformation, composition, authoring, XML processor type of processes, which aids in rapid set-up and configuration of workflow and information product and thereby quick transformation of information product with reliability and efficiency in an economical manner. The ready-to-pick process stored in process library can be picked using the GUI of project master and project master module.

The module for managing workflow services (34) can interact with another tools or application and has the capability to listen or check for messages or procedure calls from any other applications and routes the same to the workflow runtime module (35) for execution, where on initiation of workflow service, simultaneously an automated activation of auto-browsing feature, grid search feature and dynamic reporting takes place. Auto-browsing allows flexibility to application(s) to automatically browse the allocated information product for processing such that as soon application is launched, allocated information product is directly loaded with job that is allocated and on priority and opened in the application for processing for the right user, and at right step. Auto browsing restricts users to access the path as they don't need to know the physical location of file. The grid search feature is a component, which can show any rough data in a tabular form. This feature provides the users different options as to group data/filter data search data without doing any extra efforts or writing code, where the headers/columns are automatically generated, and the filter/search/grouping features are attached. The module for managing workflow services (34) is linked with the application master module. The module for managing workflow services simplifies and improves the turn-around-time to modify and implement rules, and frequently changing data processing needs and logic across the end users' environment during processing and management of information products, where changes in rules or policies that impact information product processing workflows implemented globally in an efficient manner. The said module for managing workflow services support integration of information product processing status monitoring via web services. This facilitates access to valuable information in real time.

The workflow runtime module (35) interacts with the module for managing workflow services. The said workflow runtime module (35) is used for updating scheduling, archiving and tracking activity. The real-time tracking service of the workflow runtime module helps in transforming the information product processing Process into a “closed-loop system” that is goal driven (outcome based) and sensitive to disturbances and deviations. The availability and transparency of performance data allows continuous feedback, learning, and timely and effective decision making

The windows archive database (303) is a dedicated database for storing idle or suspended workflows, which includes workflow state, context and status information. The configuration and metrics database (302) is a dedicated database for real-time storing of workflow, activity, and user performance data, time stamps, number of files processed etc. The configuration and metrics database (302) also stores records (metadata) of physical source files or transactions for processing including work-in-process and completed files. The process library (36) is also stored in configuration and metrics database including associated activity libraries and rules. A file server (FS1,FS2) is provided in each location (L1,L2), where information products are to be processed. The first location (L1) client systems (C1, C2) and file server (FS1) remain in communication with the server (301) via a data network (N1), and the second location (L2) client systems (C3, C4) and file server (FS2) remain in communication with the server (301) via another data network (N2). In another embodiment of the present invention, the file servers can be one or more or can be merged into a single file server for multiple locations. The file server can also be integrated with the server in again another embodiment of the present invention. The state of idle workflows such as no activity, no volume is stored in the Workflow archival database (303) for later reactivation when new transactions or events or volume becomes available.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for providing an efficient and a reliable process/mechanism/workflow for information products processing and transformation, the method comprising the steps of:
initiating a designing process, wherein the process comprises one or more processing units;
configuring the information product processing to product needs;
integration of the configured data with a toolkit;
visual simulation of the process;
activation of the process; and
storing the unused process for future processes in an archival database.

2. The method of claim 1, wherein the step of designing process is initiated based on the type of the product.

3. The method of claim 1, wherein the step of designing process comprises routing rules relevant information, determining a configuration stage and the type of process to be effected.

4. The method of claim 1, wherein the configuration stage is determined by invoking a multiple processes which are characteristic to a library.

5. The method of claim 3, wherein the library is a ready to use template which when incorporated gives a basic structure and function to a product.

6. The method of claim 1, wherein the step of configuring the information product processing is carried out for process-specific roles, tasks, processes, routing-rules, users, privileges of uses, skills, hierarchy levels, job priority settings, quality assurance settings, location settings and/or vendor management settings.

7. The method of claim 1, wherein the configuration is carried out without the need of programming.

8. The method of claim 7, wherein the configuration carried without programming is assigned a role which may be with a workflow or without a workflow.

9. The method of claim 7, wherein there maybe multiples roles which are created depending on the task information and determined stage.

10. The method of claim 7, wherein each role is assigned to a process, provided said role is part of the process.

11. The method of claim 10, wherein the role takes the process privilege if said role is part of the process.

12. The method of claim 1, wherein the step of configuration can either be sequential and/or parallel or conditional.

13. The method of claim 1, wherein the step of integration of the configured data with the toolkit is done via a core processing engine.

14. The method of claim 1, wherein the step of visual simulation of processed data comprises a simulation of the end-to end process and which is subject to verification for accuracy.

15. The method of claim 1, wherein the step of activation of the process is done using publishing through the Internet Information Services (IIS).

16. The method of claim 1, wherein the activation allows for queuing the processing units based on priority and skill set of the user.

17. The method of claim 1, wherein the step of activation comprises:
capturing real time matrices for each processing unit; and
updating, scheduling ,archiving and tracking

18. The method of claim 17, wherein scheduling involves creation of new process for execution in runtime memory and archiving involves maintenance of the state of processing units.

19. The method of claim 1, wherein the step of storing unused process involves auto-storage of the idle state process in an archival database for a later reactivation.

20. A system for providing an efficient and a reliable process/mechanism/workflow for information products processing and transformation, the system comprising:
an information product Builder (IPB);
a process option module (PO);
a process rule library module (PRL);
a business rule Configuratior module (BRL);
a production system (PS);
a production process module (PP);
a toolkit (SWT); and
an Infrastructure and data layer module.
